(19) United States
(12) Patent Application Publication
(10) Pub. No.: US 2026/0084238 A1
(43) Pub. Date: Mar. 26, 2026

(54) LASER PROCESSING APPARATUS AND LASER PROCESSING METHOD

(71) Applicant: Samsung Electronics Co., Ltd., Suwon-si (KR)

(72) Inventors: Youngchul KWON, Suwon-si (KR); Jungyong PARK, Suwon-si (KR); Seongman WI, Seoul (KR); Dongwon HYUN, Suwon-si (KR); Jeonghyeon HWANG, Suwon-si (KR)

(73) Assignees: Samsung Electronics Co., Ltd., Suwon-si, Gyeonggi-do (KR); EO TECHNICS CO., LTD., Anyang-si, Gyeonggi-do (KR)

(21) Appl. No.: 19/271,498

(22) Filed: Jul. 16, 2025

(30) Foreign Application Priority Data
Sep. 26, 2024 (KR) 10-2024-0130840

(51) Int. Cl. B23K 26/062; B23K 26/06; B23K 26/70; G01J 1/42

(52) U.S. Cl. CPC B23K 26/062; B23K 26/0604; B23K 26/0665; B23K 26/705; G01J 1/4257

(57) ABSTRACT

A laser processing apparatus includes a stage configured to support a substrate as a processing target and a reflective structure for measurement, a laser output portion configured to output a laser beam, a focusing lens configured to focus the laser beam on the substrate in a processing mode for processing the substrate and to focus the laser beam on the reflective structure in a measuring mode for measuring the laser beam, an aberration measuring optical system configured to receive a reflected light of the laser beam from the reflective structure through the focusing lens and to measure aberration of the laser beam, and an aberration corrector provided on an optical path of the laser beam incident from the laser output portion to the focusing lens and configured to correct the aberration of the laser beam based on the measured aberration information of the laser beam.

### PRIORITY STATEMENT

This application claims priority under 35 U.S. C. § 119 to Korean Patent Application No. 10-2024-0130840, filed on Sep. 26, 2024 in the Korean Intellectual Property Office (KIPO), the contents of which are herein incorporated by reference in their entirety.

### BACKGROUND

### 1. Field

At least some example embodiments relate to a laser processing apparatus and/or to laser processing methods. For example, some example embodiments relate to a laser processing apparatus configured to perform a laser processing process by irradiating a laser light onto a surface of a substrate and to a laser processing method using the same.

### 2. Description of the Related Art

A laser processing apparatus may process an object to be processed, such as a wafer, by focusing a pulsed laser beam with an optical lens. For example, the laser processing apparatus may perform a laser processing process such as dicing, grooving, scribing, or drilling on the object. For example, when a stealth dicing process is performed using a focusing lens having a high numerical aperture NA, an optical system such as the focusing lens may cause aberrations, thereby deteriorating processing quality. Accordingly, it may be advantageous to measure the aberration of a laser beam passing through the focusing lens and to correct the aberration of the laser beam based on the measured aberration.

### SUMMARY

At least some example embodiments relate to a laser processing apparatus that is able to measure (and/or correct) aberration of a laser beam passing through a focusing lens.

At least some example embodiments relate to a laser processing method using a laser processing apparatus according to example embodiments.

According to some example embodiments, a laser processing apparatus may include a stage configured to support a substrate as a processing target and to support a reflective structure for measurement; a laser output portion configured to output a laser beam; a focusing lens configured to focus the laser beam onto the substrate in a processing mode for processing the substrate and to focus the laser beam onto the reflective structure in a measuring mode for measuring the laser beam; an aberration measuring optical system configured to receive through the focusing lens light of the laser beam that is reflected by the reflective structure and to measure aberration of the laser beam; and an aberration corrector on an optical path of the laser beam from the laser output portion to the focusing lens, the aberration corrector configured to correct aberration of the laser beam based on measured aberration information of the laser beam.

According to some example embodiments, a laser processing apparatus may include a stage configured to support a substrate as a processing target and to support a reflective structure for measurement; a laser output portion configured to output a first laser beam having a first polarization direction and a second laser beam having a second polarization direction that is perpendicular to the first polarization direction; a focusing lens configured to focus the first and second laser beams onto the substrate in a processing mode for processing the substrate and to respectively focus the first and second laser beams onto the reflective structure in a measuring modes for measuring the first and second laser beams; an aberration measuring optical system configured to receive through the focusing lens a reflected light of each of the first and second laser beams that is reflected by the reflective structure through the focusing lens and to measure aberration of each of the first and second laser beams; a first aberration corrector provided on an optical path of the first laser beam incident from the laser output portion to the focusing lens, the first aberration corrector and configured to correct the aberration of the first laser beam based on measured aberration information of the measured first laser beam; and a second aberration corrector provided on an optical path of the second laser beam incident from the laser output portion to the focusing lens, the second aberration corrector and configured to correct the aberration of the second laser beam based on the measured aberration information of the second laser beam.

According to some example embodiments, a laser processing apparatus may include a stage configured to support a reflective structure; a laser output portion configured to output a laser beam; a focusing lens configured to focus the laser beam on the reflective structure; an aberration measuring optical system configured to receive through the focusing lens light of the laser beam that is reflected by the reflective structure to measure aberration of the laser beam; and an aberration corrector provided on an optical path of the laser beam from the laser output portion to the focusing lens, the aberration corrector and configured to correct the aberration of the laser beam based on the measured aberration information of the laser beam, and the aberration measuring optical system includes: a polarizing beam splitter configured to transmit a laser beam having a first polarization direction and to reflect a laser beam having a second polarization direction that is perpendicular to the first polarization direction; at least one wavelength plate on an optical path between the polarizing beam splitter and the reflective structure, the at least one wavelength plate configured to change the polarization direction of a laser beam transmitted through the polarizing beam splitter; and an aberration sensor configured to receive a reflected light of the laser beam that is reflected by the polarizing beam splitter, the aberration sensor configured to measure the aberration of the laser beam, wherein the at least one wavelength plate is on the optical path or outside the optical path.

According to some example embodiments, a laser processing apparatus may include a laser output portion configured to output a laser beam, a focusing lens configured to focus the laser beam onto a substrate in a processing mode and to focus the laser beam onto a reflective structure in a measuring mode, an aberration measuring optical system configured to receive a reflected light of the laser beam from the reflective structure through the focusing lens to measure aberration of the laser beam, and an aberration corrector to correct the aberration of the laser beam based on the measured aberration information of the laser beam.

According to some example embodiments, a laser processing method may include placing a reflective structure on a stage, emitting a laser beam from a laser output portion, focusing the laser beam onto the reflective structure through a focusing lens, receiving through the focusing lens light of the laser beam that is reflected by the reflective structure, correcting aberration of the laser beam based on aberration information of the reflected light that is received through the focusing lens, placing a substrate on the stage, focusing the corrected laser beam onto the substrate, the corrected laser beam being focused through the focusing lens, and scanning the corrected laser beam along one or more cutting lines of the substrate.

According to some example embodiments, the laser processing method may further include obtaining the aberration information during a measuring mode of the laser processing apparatus by measuring aberration of the laser beam using an aberration optical system. the aberration optical system including an aberration optical path forming portion and an aberration sensor.

According to some example embodiments, the laser processing method may further include guiding to the aberration sensor the reflected light that is received through the focusing lens, the guiding using the optical path forming portion.

According to some example embodiments, the laser processing method may further include correcting the aberration of the laser beam by using an aberration corrector, the correcting being based on the aberration information measured by the aberration measuring optical system.

According to some example embodiments, the laser processing method may include measuring the aberration information of the laser beam by using an aberration measuring optical system, the aberration measuring optical system including a polarizing beam splitter, at least one wavelength plate, and an aberration sensor, the polarizing beam splitter configured to transmit a laser beam having a first polarization direction and to a reflect a laser beam having a second polarization direction, the at least one wavelength plate on an optical path between the polarizing beam splitter and the reflective structure and configured to change the polarization direction of a laser beam transmitted through the polarizing beam splitter; and an aberration sensor configured to receive light of the laser beam that is reflected by the polarizing beam splitter, the aberration sensor configured to measure the aberration of the laser beam.

According to some example embodiments, a laser processing method may include placing a reflective structure on a stage, emitting a first laser beam and a second laser beam from a laser output portion, the first laser beam having a first polarization direction and the second laser beam having a second polarization direction that is perpendicular to the first polarization direction, focusing the first and second laser beams onto the reflective structure through a focusing lens, receiving through the focusing lens light of each of first and second laser beams that is reflected by the reflective structure, correcting aberration of the first and second laser beams based on aberration information of the reflected light that is received through the focusing lens, placing a substrate on the stage, focusing the corrected first and second laser beams onto the substrate, the corrected first and second laser beams being focused through the focusing lens, and scanning the corrected first and second laser beams along one or more cutting lines of the substrate.

The aberration measuring optical system may measure the aberration of the laser beam that has passed through the focusing lens in the measuring mode without affecting or substantially affecting the propagation of the laser beam in the processing mode. The aberration corrector may adjust a phase of the laser beam based on the measured aberration information to correct the aberration of the laser beam, to accordingly improve the processing quality of the laser beam.

### BRIEF DESCRIPTION OF THE DRAWINGS

Various example embodiments will be more clearly understood from the following detailed description taken in conjunction with the accompanying drawings. FIGS. 1 to 16 relate to various non-limiting example embodiments as described herein.

FIG. 1 is a perspective view illustrating a laser processing apparatus in accordance with example embodiments.

FIG. 2 is a block diagram illustrating a laser irradiator in FIG. 1.

FIG. 3 is a block diagram illustrating a measuring mode of laser beam performed in the laser processing apparatus of FIG. 1.

FIG. 4 is a block diagram illustrating a processing mode performed in the laser processing apparatus of FIG. 1.

FIG. 5A is a cross-sectional view illustrating a portion of an aberration sensor of the laser processing apparatus of FIG. 1.

FIG. 5B is a plan view illustrating spots detected in pixels of an image sensor of FIG. 5A.

FIG. 6 is a block diagram illustrating a laser processing apparatus in accordance with example embodiments.

FIG. 7 is a block diagram illustrating a measuring mode of first laser beam performed in the laser processing apparatus of FIG. 6.

FIG. 8 is a block diagram illustrating a measuring mode of second laser beam performed in the laser processing apparatus of FIG. 6.

FIG. 9 is a block diagram illustrating a processing mode performed in the laser processing apparatus of FIG. 6.

FIG. 10 is a block diagram illustrating a laser processing apparatus in accordance with example embodiments.

FIG. 11 is a block diagram illustrating a measuring mode of first laser beam performed in the laser processing apparatus of FIG. 10.

FIG. 12 is a block diagram illustrating a measuring mode of second laser beam performed in the laser processing apparatus of FIG. 10.

FIG. 13 is a block diagram illustrating a processing mode performed in the laser processing apparatus of FIG. 10.

FIG. 14 is a flow chart illustrating a laser processing method in accordance with example embodiments.

FIG. 15 is a cross-sectional view illustrating a wafer irradiated with two first and second laser beams.

FIG. 16 is a plan view illustrating a scan line on the wafer along which the first and second laser beams of FIG. 15 are scanned.

### DETAILED DESCRIPTION OF EXAMPLE EMBODIMENTS

Hereinafter, various example embodiments will be explained in detail with reference to the accompanying drawings.

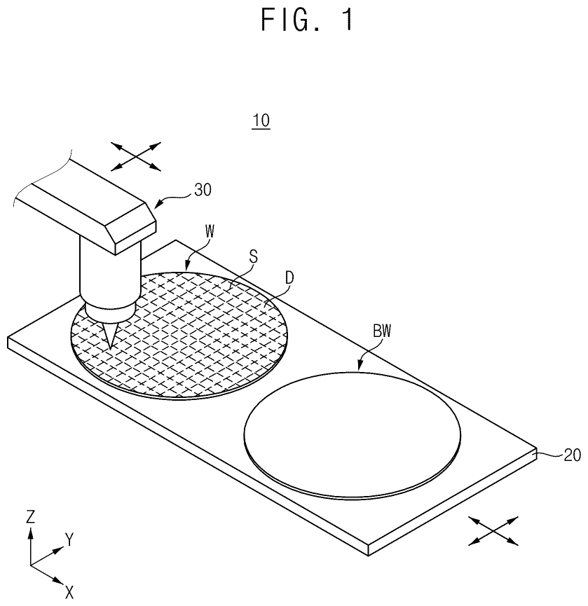

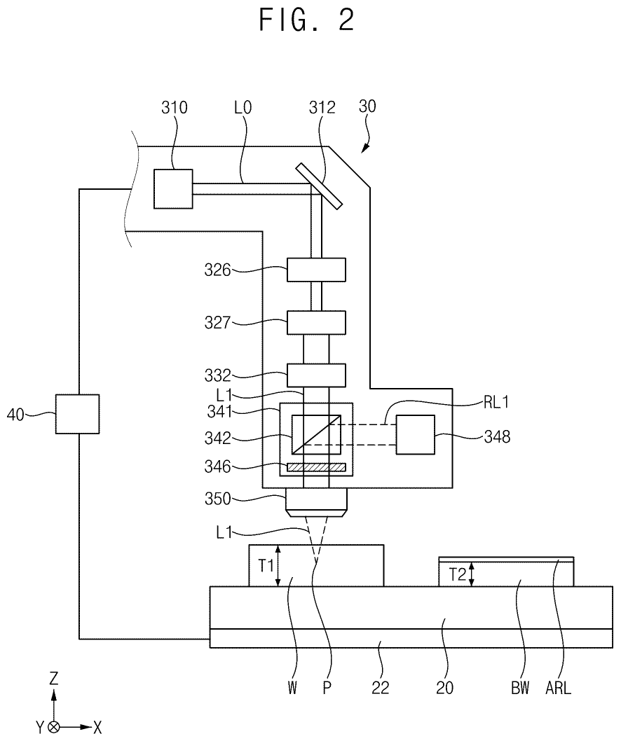

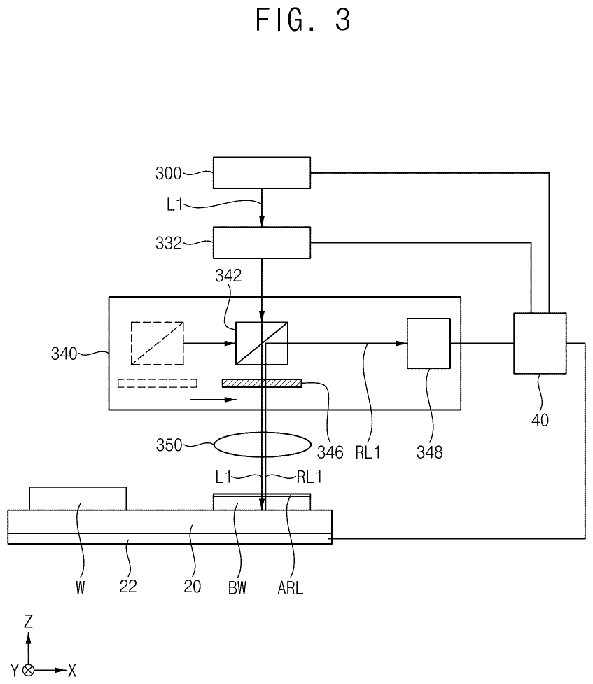

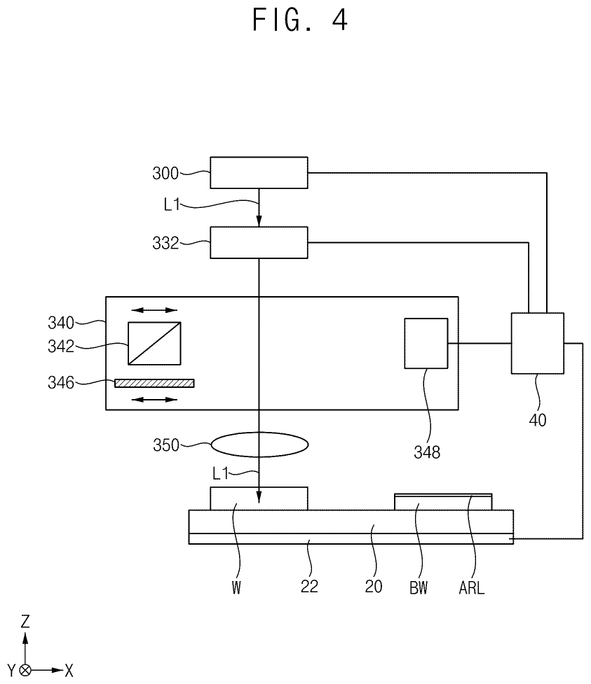

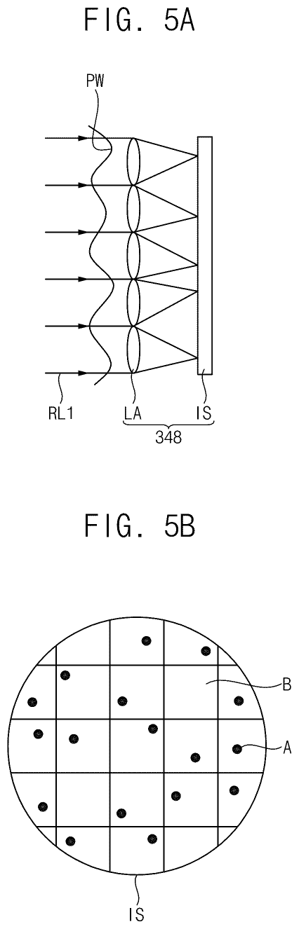

FIG. 1 is a perspective view illustrating a laser processing apparatus in accordance with example embodiments. FIG. 2 is a block diagram illustrating a laser irradiator in FIG. 1. FIG. 3 is a block diagram illustrating a measuring mode of laser beam performed in the laser processing apparatus of FIG. 1. FIG. 4 is a block diagram illustrating a processing mode performed in the laser processing apparatus of FIG. 1. FIG. 5A is a cross-sectional view illustrating a portion of an aberration sensor of the laser processing apparatus of FIG. 1, and FIG. 5B is a plan view illustrating spots detected in pixels of an image sensor of FIG. 5A.

Referring to FIGS. 1 to 5B, a laser processing apparatus 10 may include a stage 20 and a laser irradiator 30. The laser processing apparatus 10 may further include a controller 40 connected to the stage 20 and the laser irradiator 30 to control their operations.

In some example embodiments, the laser processing apparatus 10 may irradiate a laser beam L1 within a substrate W such as a wafer to apply local high density energy into a focal point P, to accordingly form a stealth dicing layer as a modified region. The laser processing apparatus 10 may scan the laser beam L1 along a scan line S on the substrate W. Accordingly, a laser damage layer, which is the modified region, may be formed within the substrate W along the scan line. The laser damage layers formed along the scan line, e.g., a scribe lane region, may be a cutting starting point region.

The laser processing apparatus 10 may further include a driving portion configured to move the laser beam L1 relative to the substrate W. The driving portion may include a stage driver 22 configured to move the stage 20 in X, Y, and Z-axis directions.

For example, the stage 20 may be a table that is movable in at least one direction and supports the substrate W. The stage 20 may be installed on the stage driver 22 so as to be movable in at least the X direction and Y direction. The stage driver 22 includes a stage driving mechanism for moving the stage 20, and the stage driver 22 may move the stage 20 in X and Y directions according to a control signal of the controller 40. A moving speed of the stage 20 may be adjustable.

The driving portion may further include a laser head driver configured to move the laser irradiator 30 in X, Y, and Z directions. For example, the laser head driver may move an optical system of the laser irradiator 30 in X, Y, and Z directions. For examples, the laser head driver may move the laser irradiator 30 in Z direction, and the stage driver 22 may rotate the stage 20 to move the wafer W in X and Y directions and rotate around a center of the wafer W.

As illustrated in FIGS. 2, 3, and 4, the laser irradiator 30 may include a laser output portion 300 to output a laser beam L1, a focusing lens 350 to focus the laser beam L1 onto the substrate W, and an aberration measuring optical system 340 to measure aberration of the laser beam L1 passing through the focusing lens 350. The laser irradiator 30 may further include an aberration corrector 332 to correct the aberration of the laser beam L1 based on the aberration information of the measured laser beam.

The stage 20 may support a substrate W as a processing target and a reflective structure BW for measuring the laser beam. The stage 20 may move the substrate W and the reflective structure BW based on an operation mode.

For example, the stage 20 may position the substrate W at a focus of the focusing lens 350 in a processing mode for processing the substrate W. In the processing mode, the stage driver 22 may move the stage 20 according to the control signal of the controller 40 so that the substrate W is positioned at the focus of the focusing lens 350. The stage 20 may position the reflective structure BW at the focus of the focusing lens 130 in the measuring mode of the laser beam L1. In the measuring mode, the stage driver 22 may move the stage 20 according to the control signal of the controller 40 so that the reflective structure BW is positioned at the focus of the focusing lens 350.

For example, the substrate W may include a silicon wafer (Si Wafer), a silicon carbide wafer (SiC Wafer), a gallium arsenide wafer (GaAs Wafer), or a silicon single crystal wafer (Si-Single Crystal Wafer). The substrate W may have a plurality of die regions D arranged in a matrix shape and separated by cutting regions S. Circuit elements may be formed in an active surface of the substrate W.

The reflective structure BW may include a reflective mirror. The reflective structure BW may include a material the same as the material of the substrate W. For example, the reflective structure BW may include a substrate such as a silicon wafer (Si Wafer). The reflective structure BW may be a wafer before processing, e.g., a bare wafer. A thickness of the reflective structure BW may be determined depending on a type of the laser processing apparatus 10 and a thickness T1 of the substrate W as the processing target. The reflective structure BW may have a thickness of 40% to 60% of the thickness T1 of the substrate W. When the thickness of the substrate W is 700 μm, the reflective structure BW may include a thickness T2 of about 350 μm. As described below, a laser beam may be focused on an upper surface of a reflective mirror BW disposed on the stage 20, and the laser beam may pass therethrough, may be reflected from the reflective mirror and then may pass back through the reflective mirror. Accordingly, the transmission and back transmission of the reflective mirror BW may correspond to the unidirectional transmission of the substrate W.

An anti-reflection layer ARL may be coated on the upper surface of the reflective structure BW. The anti-reflection layer ARL may reduce, limit, or prevent surface reflection of the reflective structure BW, so that most of the laser beam incident on the upper surface of the reflective structure BW may pass through the reflective structure BW, and then pass through again to be emitted as a reflected light through the upper surface of the reflective structure BW.

The laser output portion 300 may include a laser light source 310 to generate a laser beam L0. For example, the laser light source 310 as a single light source may emit the laser beam L0. The laser beam L0 may have a wavelength band having transparency to the substrate W, which is an objected to be processed. The wavelength band may be within a wavelength range of 1,080 nm to 1,100 nm. The laser light source 310 may emit a pulsed laser beam. However, inventive concepts are not limited thereto, and may emit a continuous wave laser beam depending on the type of processing operation. The laser beam L0 may be an ultra-short pulse laser beam having a pulse width of 1 μs or less, for example, on a picosecond order or a femtosecond order.

The laser output portion 300 may further include a power controller 326 to adjusting a waveform and power of the laser beam L0 and a beam expander 327 to expand a diameter of the laser beam. The laser output portion 300 may further include a laser measurement portion to measure the waveform, power, etc. of the outputted laser beam. The laser measurement portion may measure a pulse width, rising time, pulse peak, etc. of the laser beam. The laser measurement portion may include at least one photodiode PD sensor.

The power controller 326 may adjust the waveform and power of the laser beam so that the measured value measured by the laser output portion satisfies a predetermined or, alternatively, desired standard. The beam expander 327 may expand the diameter of a collimated input beam and output a collimated output beam having a larger diameter. The beam expander 327 may be configured by a combination of a plurality of lenses. The beam expander 327 may adjust a beam size while maintaining the same output value.

In some example embodiments, the aberration corrector 332 may be provided on an optical path of the laser beam L1 incident from the laser output portion 300 to the focusing lens 350 and may correct the aberration of the laser beam. The aberration corrector 332 may correct the aberration of the laser beam L1 based on the aberration information of the laser beam measured by the aberration measuring optical system 340. The aberration corrector 332 may include a spatial light modulator SLM. The spatial light modulator may be provided on the optical path of the laser beam L1 and may modulate a phase of the laser beam L1. The spatial light modulator may be an optical device that may spatially modulate a beam. The spatial light modulator may include optical elements in a form of a two-dimensional array.

As described below, the controller 40 may calculate whether to correct aberration and a correction value for removing the aberration based on the aberration information acquired from the aberration measuring optical system 340, and output a control signal for reflecting the calculated correction value to the aberration corrector 332. Each pixel of the spatial light modulator may change its optical characteristics by an electric signal from the controller 40, thereby changing the phase of the laser beam incident on each pixel. The spatial light modulator may spatially control the phase of the laser beam.

The focusing lens 350 may focus the laser beam L1 that has passed through the aberration corrector 332 onto the substrate W or the reflective structure BW on the stage 20. The focusing lens 345 may be provided on the optical path of the laser beam and may include a single lens optical system having a numerical aperture NA of at least 0.6. For example, the focusing lens 350 may include a single lens optical system in which a plurality of lenses are sequentially arranged.

In some example embodiments, the aberration measuring optical system 340 may measure the aberration of the laser beam by receiving a reflected light RL1 of the laser beam from the reflective structure BW through the focusing lens 350. The aberration measuring optical system 340 may include an optical path forming portion 341 and an aberration sensor 348. The optical path forming portion 341 may guide the reflected light RL1 of the laser beam from the reflective structure BW that passes through the focusing lens 350, to the aberration sensor 348. The optical path forming portion 341 may transmit the laser beam L1 provided from the laser output portion 300 to the focusing lens 350, and may transmit the laser beam RL1 reflected by the reflective structure BW after passing through the focusing lens 350, to the aberration sensor 348. The optical path forming portion 341 may include a polarizing beam splitter 342 and a wavelength plate 346. I The optical path forming portion 341 may further include optical elements such as at least one mirror, at least one lens, etc.

The polarizing beam splitter 342 may transmit a laser beam having a first polarization direction and may reflect a laser beam having a second polarization direction perpendicular to the first polarization direction. The wavelength plate 346 may be disposed on an optical path between the polarizing beam splitter 342 and the reflective structure BW to change a polarization direction of the laser beam that has passed through the polarizing beam splitter 342. The wavelength plate 346 may include a quarter-wavelength plate. The polarizing beam splitter 342 and the wavelength plate 346 may be provided to be movable according to the operation mode of the laser processing apparatus 10. The laser processing apparatus 10 may include a movement mechanism to move the polarizing beam splitter 342 and the wavelength plate 346. The movement mechanism may move the polarizing beam splitter 342 and the wavelength plate 346 based on the control signal from the controller 40.

As illustrated in FIG. 3, in the measuring mode for measuring the aberration of the laser beam L1, the polarizing beam splitter 342 and the wavelength plate 346 may be disposed on the optical path between the aberration corrector 332 and the focusing lens 350. The polarizing beam splitter 342 and the wavelength plate 346 may move in the first direction (X direction) based on the operation mode. The focusing lens 350 may focus the laser beam L1 that has passed through the polarizing beam splitter 342 onto the reflective structure BW that is supported on the stage 20. For example, the polarizing beam splitter 342, the wavelength plate 346, and the focusing lens 350 may be located on the same axis.

For example, the laser output portion 300 may output a laser beam L1 having a first polarization direction, for example, P polarization, and the polarizing beam splitter 342 may transmit the laser beam L1 having the first polarization direction. The laser beam L1 having the first polarization direction may pass through the wavelength plate 346 and then may be incident on the reflective structure BW, and the reflected light RL1 of the laser beam may pass through the wavelength plate 346 and may be incident again to the polarizing beam splitter 342. The wavelength plate 346 may delay a phase of light passing therethrough by, for example, ¼ wavelength. The reflected light RL1 of the laser beam incident again to the polarizing beam splitter 342 may be changed to have a second polarization direction, that is, S polarization, as the laser beam passes through the wavelength plate 346 twice.

The polarizing beam splitter 342 may reflect the laser beam having the second polarization direction, so the polarizing beam splitter 342 may reflect the reflected light RL1 of the laser beam. Accordingly, the reflected light RL1 of the laser beam may be incident on the aberration sensor 348.

Accordingly, the laser processing apparatus 10 may adjust the polarization direction of the laser beam L1 using the optical path forming portion 341, so that the laser beam L1 passing through the focusing lens 350 may be received by the aberration sensor 348.

The aberration sensor 348 may receive the laser beam transmitted through the optical path forming portion 341. The aberration sensor 348 may receive the laser beam that has passed through the focusing lens 350. As described below, the aberration sensor 348 may include a wavefront sensor for measuring a wavefront of the received laser beam. The controller 40 may analyze the aberration of the laser beam measured through the aberration sensor 348, may calculate a correction value for making the value of each type of aberration approach zero, and may output a control signal reflecting the correction value to the aberration corrector 332. The aberration corrector 332 may modulate the phase of the laser beam L1 in response to the control signal. Accordingly, the aberration of the laser beam L1 may be removed, limited, or reduced.

As illustrated in FIG. 4, in the processing mode for processing the substrate W, the polarizing beam splitter 342 and the wavelength plate 346 may be placed outside the optical path between the aberration corrector 332 and the focusing lens 350. The polarizing beam splitter 342 and the wavelength plate 346 may move in a direction (−X direction) opposite to the first direction based on the operation mode. Accordingly, the laser beam L1 may be focused onto the substrate W, which is the processing target, without passing through the polarizing beam splitter 342 and the wavelength plate 346. Accordingly, the aberration sensor 348 may not receive the reflected light of the laser beam L1.

The driving portion of the laser processing apparatus 10 may move the laser beam L1 in a second horizontal direction different from the first horizontal direction (X direction) with respect to the substrate W to scan the laser beam L1 along the cutting lines S on the substrate W. For example, the second horizontal direction may be a direction (Y direction) perpendicular to the first horizontal direction (X direction).

The stage 20 may be moved in one direction at a predetermined or, alternatively, desired moving speed by the stage driver 22. A scanning speed of the laser beam L1 may be, for example, determined by or based on the moving speed of the stage 20, but example embodiments are not limited thereto. The scanning speed of the laser beam L1 may be, for example, within a range of 300 mm/s to 2000 mm/s, but example embodiments are not limited thereto.

As illustrated in FIGS. 5A and 5B, the aberration sensor 348 may include a lenslet array LA and an image sensor IS. The aberration sensor 348 may include, for example, a Shack-Hartmann wavefront sensor. Pixels of the image sensor IS may detect a plurality of images formed by the lenslet array LA.

When a distortion-free wavefront passes through the lenslet array LA, each position of the plurality of images formed on the image sensor IS may be referred to as a reference spot. The wavefront PW of the laser beam LA incident on the lenslet array LA of the aberration sensor 348 is distorted due to aberration caused by the focusing lens 350, and accordingly, focal points A, B detected by the pixels of the image sensor IS may change. A slope of the wavefront may be calculated by calculating a displacement difference between the reference spot and the changed spot at each pixel. A two-dimensional distribution map of the entire wavefront may be constructed based on the measured slope information. The measured wavefront may be expanded into a Zernike polynomial. Coefficients of the Zernike polynomial may be calculated from the displacement difference. Each of the coefficients may represent a specific aberration.

The controller 40 may calculate a correction value that makes the value of each type of aberration approach zero using the calculated coefficients, and may output a control signal reflecting the correction value to the aberration corrector 332. The aberration corrector 332 may modulate the phase of the laser beam L1 in response to the control signal. Each pixel of the spatial light modulator may have its optical characteristics individually adjusted to compensate for a specific aberration. For example, when correcting spherical aberration, the optical characteristics of pixels at the center and pixels at the periphery of the spatial light modulator may be modulated to be different, and when correcting coma aberration, the optical characteristics of pixels on the left and right of the spatial light modulator may be modulated to be different.

As described above, the laser processing apparatus 10 may include the laser output portion 300 to output the laser beam L1, the focusing lens 350 to focus the laser beam L1 on the substrate W in the processing mode and to focus the laser beam L1 on the reflective structure BW in the measuring mode, the aberration measuring optical system 340 to measure the aberration of the laser beam by receiving the reflected light RL1 of the laser beam from the reflective structure BW through the focusing lens 350, and the aberration corrector 332 to correct the aberration of the laser beam based on the aberration information of the measured laser beam.

The aberration measuring optical system 340 may measure the aberration of the laser beam L1 that has passed through the focusing lens 350 in the measuring mode without affecting the propagation of the laser beam L1 in the processing mode. The aberration corrector 332 may adjust the phase of the laser beam L1 based on the measured aberration information to correct the aberration of the laser beam L1, to accordingly improve the processing quality of the laser beam.

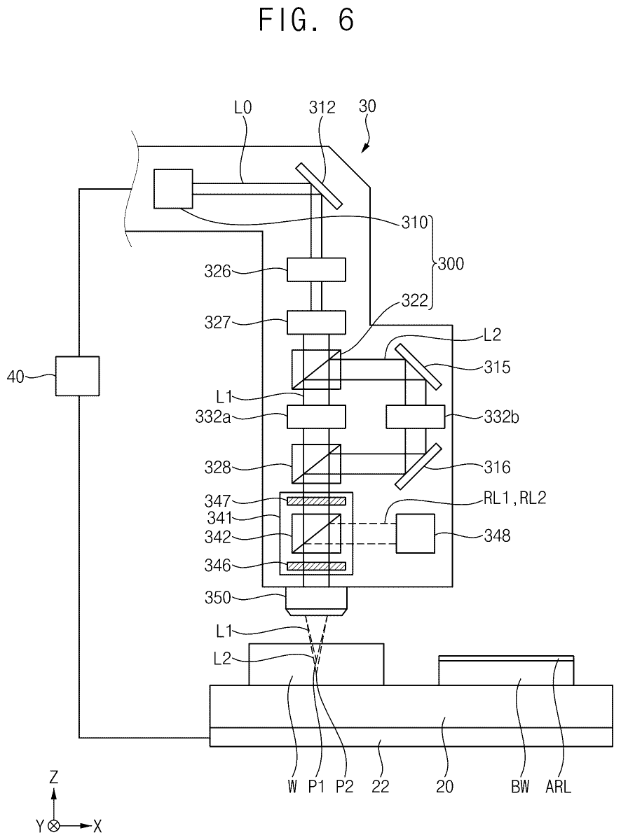

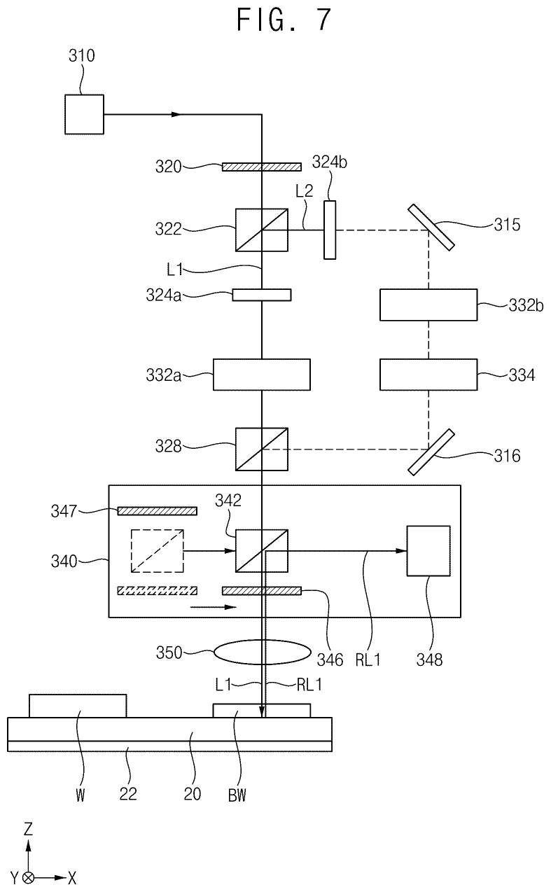

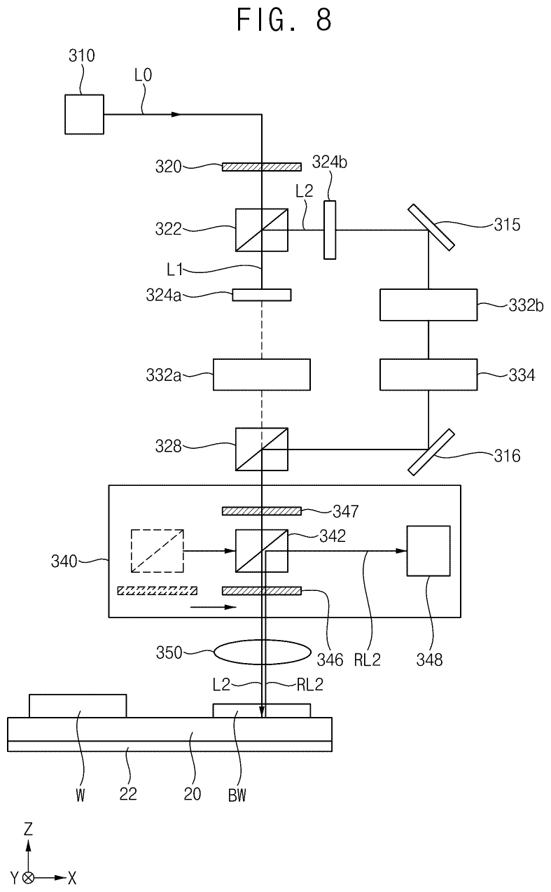

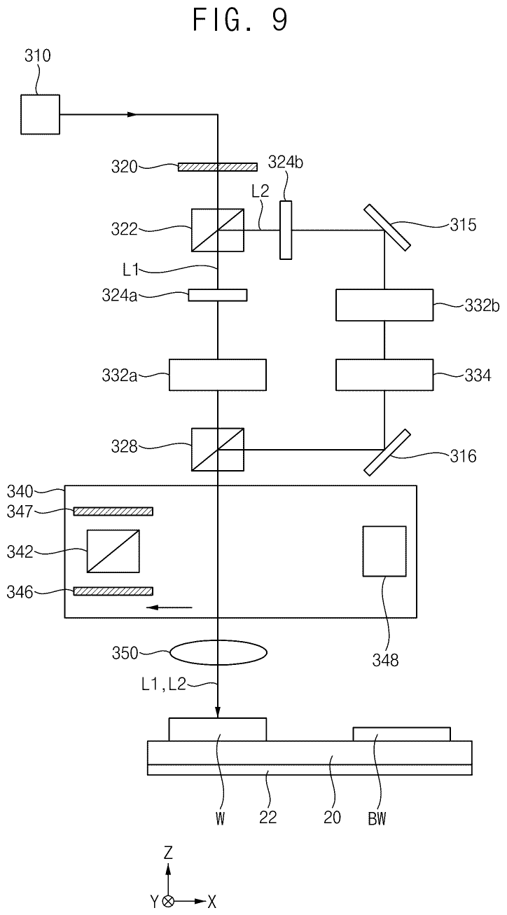

FIG. 6 is a block diagram illustrating a laser processing apparatus in accordance with some example embodiments. FIG. 7 is a block diagram illustrating a measuring mode of first laser beam performed in the laser processing apparatus of FIG. 6. FIG. 8 is a block diagram illustrating a measuring mode of second laser beam performed in the laser processing apparatus of FIG. 6. FIG. 9 is a block diagram illustrating a processing mode performed in the laser processing apparatus of FIG. 6. The laser processing apparatus may be the same as or substantially the same as the laser processing apparatus described with reference to FIGS. 1 to 4, except for a configuration of a laser output portion that outputs first and second laser beams and configurations of an aberration measuring optical system and an aberration corrector. Thus, same reference numerals will be used to refer to the same or like elements and any further repetitive explanation concerning the above elements will be omitted.

Referring to FIGS. 6 to 9, a laser irradiator 30 may include a laser output portion 300 to output a first laser beam L1 and a second laser beam L2, a focusing lens 350 to focus the first laser beam L1 and the second laser beam L2 onto a substrate W, and an aberration measuring optical system 340 to measure aberration of the first laser beam L1 and the second laser beam L2 passing through the focusing lens 350. The laser irradiator 30 may further include a first aberration corrector 332a to correct the aberration of the first laser beam L1 based on the aberration information of the measured first laser beam, and a second aberration corrector 332b to correct the aberration of the second laser beam L2 based on the aberration information of the measured second laser beam.

In some example embodiments, the laser output portion 300 may include a beam splitter 322 to split a laser beam L0 from a laser light source 310 into a first laser beam L1 and a second laser beam L2. The laser output portion 300 may further include a wavelength plate 320 to change a polarization component of the laser beam L0 from the laser light source 310, a first beam block portion 324a provided in an optical path of the first laser beam L1 split by the beam splitter 322 to selectively block the first laser beam L1, and a first beam block portion 324b provided in an optical path of the second laser beam L2 split by the beam splitter 322 to selectively block the second laser beam L2. For example, the wavelength plate 320 may include a half wavelength plate. The beam splitter 322 may include a polarizing beam splitter. The first beam block portion 324a and the second beam block portion 324b may include optical shutters.

For example, the laser beam L0 from the laser light source 310 may pass through the wavelength plate 320. The wavelength plate 320 may change polarization of the laser beam L0. For example, the wavelength plate 320 may adjust the polarization of the laser beam L0 so that the polarization component of the laser beam L0 includes 50% P polarization and 50% S polarization, but example embodiments are not limited thereto.

The laser beam L0 passing through the wavelength plate 320 may be split into the first laser beam L1 and the second laser beam L2 by the beam splitter 322 based on the polarization. For example, the first laser beam L1 may be S polarized and the second laser beam L2 may be P polarized.

The first laser beam L1 may pass through the first aberration corrector 332a to the polarizing beam splitter 328, and the second laser beam L2 may pass through the second aberration corrector 332b to the polarizing beam splitter 328. The first beam block portion 324a may be provided on a first optical path between the beam splitter 322 and the first aberration corrector 332a to selectively block the first laser beam L1. The second beam block portion 324b may be provided on a second optical path between the beam splitter 322 and the second aberration corrector 332b to selectively block the second laser beam L2.

The polarizing beam splitter 328 may transmit the first laser beam L1 having the first polarization direction (P polarization) and may reflect the second laser beam L2 having the second polarization direction (S polarization). The focusing lens 350 may focus the first laser beam L1 passing through the polarizing beam splitter 328 onto a substrate W or a reflective structure BW on the stage 20 and may focus the second laser beam L2 reflected by the polarizing beam splitter 328 onto the substrate W or the reflective structure BW on the stage 20.

In some example embodiments, a focus position adjuster 334 may be provided on the first optical path of the first laser beam L1 and/or the second optical path of the second laser beam L2 to adjust a focus position P1 of the first laser beam L1 and/or a focus position P2 of the second laser beam L2. The focus position adjuster 334 may adjust the focus position P1 of the first laser beam L1 and the focus position P2 of the second laser beam L2 to be different from each other. The focus position adjuster 334 may include a spatial light modulator SLM, but example embodiments are not limited thereto.

The focus position adjuster 334 may be provided on the second optical path of the second laser beam L2 and may modulate a phase of the second laser beam L2. Alternatively, the focus position adjuster 334 may be provided on the first optical path of the first laser beam L1. Additionally, the first aberration corrector 332a and the second aberration corrector 332b may perform a role of the focus position adjuster, and in such a case, the focus position adjuster 334 may be omitted.

The first and second laser beams L1, L2 may be focused such that the focus position P1 of the first laser beam L1 and the focus position P2 of the second laser beam L2 are different from each other. In a processing mode, the first laser beam L1 may have a focus position P1 at a first depth d1 from a surface of the substrate W, and the second laser beam L2 may have a focus position P2 at a second depth d2 greater than the first depth from the surface of the substrate W. Accordingly, the focus positions P1, P2 of the first and second laser beams L1, L2 may have the same XY plane coordinate.

In some example embodiments, the aberration measuring optical system 340 may measure the aberration of the first laser beam and the second laser beam by receiving a reflected light RL1 of the first laser beam and a reflected light RL2 of the second laser beam from the reflective structure BW through the focusing lens 350. The aberration measuring optical system 340 may include an optical path forming portion 341 and an aberration sensor 348. The optical path forming portion 341 may guide the reflected light RL1 of the first laser beam and the reflected light RL2 of the second laser beam from the reflective structure BW that propagate through the focusing lens 350, to the aberration sensor 348. The optical path forming portion 341 may transmit the first and second laser beams L1, L2 provided from the laser output portion 300 to the focusing lens 350, and may transmit the laser beams RL1, RL2 reflected by the reflective structure BW after passing through the focusing lens 350 to the aberration sensor 348. The optical path forming portion 341 may include a polarizing beam splitter 342, a quarter wavelength plate 346, and a half wavelength plate 347. The optical path forming portion 341 may further include optical elements such as, for example, at least one mirror, at least one lens, etc.

The polarizing beam splitter 342 may transmit a laser beam having a first polarization direction and may reflect a laser beam having a second polarization direction perpendicular to the first polarization direction. The quarter wavelength plate 346 may be provided on an optical path between the polarizing beam splitter 342 and the reflective structure BW to change a polarization direction of the laser beam that has passed through the polarizing beam splitter 342. The half wavelength plate 347 may be provided on an optical path of the second laser beam L2 incident from the laser output portion 300 to the polarizing beam splitter 342 to change a laser beam having the second polarization direction into a laser beam having the first polarization direction. The quarter wavelength plate 346 and the half wavelength plate 347 may be provided to be movable according to the operation mode of the laser processing apparatus 10. The laser processing apparatus 10 may include a movement mechanism to move the quarter wavelength plate 346 and the half wavelength plate 347. The movement mechanism may move the quarter wavelength plate 346 and the half wavelength plate 347 based on a control signal from a controller 40.

As illustrated in FIG. 7, in a first measuring mode for measuring aberration of the first laser beam L1, the polarizing beam splitter 342 and the quarter wavelength plate 346 may be disposed on an optical path between the polarizing beam splitter 328 and the focusing lens 350. The quarter wavelength plate 346 may move in a first direction (X direction) based on the operation mode. The focusing lens 350 may condense the first laser beam L1 that has passed through the polarizing beam splitter 342 onto the reflective structure BW supported on the stage 20. For example, the polarizing beam splitter 342, the quarter wavelength plate 346, and the focusing lens 350 may be located on the same axis.

For example, the first beam block portion 324a may allow the passage of the first laser beam L1, and the second beam block portion 324b may block the second laser beam L2. Accordingly, the laser output portion 300 may output the first laser beam L1 having a first polarization direction (P polarization), and the polarizing beam splitter 342 may transmit the first laser beam L1 having the first polarization direction. The first laser beam L1 having the first polarization direction may pass through the quarter wavelength plate 346 and then may be incident on the reflective structure BW, and the reflected light RL1 of the first laser beam may pass through the quarter wavelength plate 346 and may be incident again to the polarizing beam splitter 342. The quarter wavelength plate 346 may delay a phase of light passing therethrough by ¼ wavelength. The reflected light RL1 of the first laser beam incident again to the polarizing beam splitter 342 may be changed to have a second polarization direction (S polarization), as the laser beam passes through the quarter wavelength plate 346 twice.

The polarizing beam splitter 342 may reflect the laser beam having the second polarization direction, so the polarizing beam splitter 342 may reflect the reflected light RL1 of the first laser beam. Accordingly, the reflected light RL1 of the first laser beam may be incident on the aberration sensor 348.

Thus, the laser processing apparatus 10 may adjust the polarization direction of the first laser beam L1 using the optical path forming portion 341, so that the first laser beam L1 passing through the focusing lens 350 may be received by the aberration sensor 348.

The aberration sensor 348 may measure the aberration of the first laser beam L1 transmitted through the optical path forming portion 341. The controller 40 may analyze the aberration information of the first laser beam measured through the aberration sensor 348, may calculate a correction value for making the value of each type of aberration approach zero, and may output a control signal reflecting the correction value to the first aberration corrector 332a. The first aberration corrector 332a may modulate the phase of the first laser beam L1 in response to the control signal. Accordingly, the aberration of the first laser beam L1 may be removed, limited, or reduced.

As illustrated in FIG. 8, in a second measuring mode for measuring aberration of the second laser beam L2, the half wavelength plate 347, the polarizing beam splitter 342 and the quarter wavelength plate 346 may be disposed on the optical path between the polarizing beam splitter 328 and the focusing lens 350. The half wavelength plate 347 and the quarter wavelength plate 346 may move in the first direction (X direction) based on the operation mode. The focusing lens 350 may condense the second laser beam L2 that has passed through the polarizing beam splitter 342 onto the reflective structure BW supported on the stage 20. For example, the half wavelength plate 347, the polarizing beam splitter 342, the quarter wavelength plate 346, and the focusing lens 350 may be located on the same axis.

For example, the first beam block portion 324a may block the first laser beam L1, and the second beam block portion 324b may allow the passage of the second laser beam L2. Accordingly, the laser output portion 300 may output the second laser beam L2 having a second polarization direction (S polarization), and the second laser beam L2 may pass through the half wavelength plate 347 and then may be incident on the polarizing beam splitter 342. The polarization of the second laser beam L2 may be changed as the second laser beam passes through the half wavelength plate 347. The second laser beam L2 that has passed through the half wavelength plate 347 may have the first polarization direction (P polarization). The polarizing beam splitter 342 may transmit the second laser beam L2 having the first polarization direction.

The second laser beam L2 having the first polarization direction may pass through the quarter wavelength plate 346 and may be incident on the reflective structure BW, and the reflected light RL2 of the second laser beam may pass through the quarter wavelength plate 346 and may be incident again to the polarizing beam splitter 342. The quarter wavelength plate 346 may delay a phase of light passing therethrough by ¼ wavelength. The reflected light RL2 of the second laser beam incident again to the polarizing beam splitter 342 may be changed to have the second polarization direction (S polarization), as the laser beam passes through the quarter wavelength plate 346 twice.

Since the polarizing beam splitter 342 reflects the laser beam having the second polarization direction, the polarizing beam splitter 342 may reflect the reflected light RL2 of the second laser beam. Accordingly, the reflected light RL2 of the second laser beam may be incident on the aberration sensor 348.

Accordingly, the laser processing apparatus 10 may adjust the polarization direction of the second laser beam L2 using the optical path forming portion 341, so that the second laser beam L1 passing through the focusing lens 350 may be received by the aberration sensor 348.

The aberration sensor 348 may measure the aberration of the second laser beam L2 transmitted through the optical path forming portion 341. The controller 40 may analyze the aberration information of the second laser beam measured through the aberration sensor 348, may calculate a correction value for making the value of each type of aberration approach zero, and may output a control signal reflecting the correction value to the second aberration corrector 332b. The second aberration corrector 332b may modulate the phase of the second laser beam L2 in response to the control signal. Accordingly, the aberration of the second laser beam L2 may be removed or reduced.

As illustrated in FIG. 9, in the processing mode for processing the substrate W, the polarizing beam splitter 342, the quarter wavelength plate 346 and the half wavelength plate 347 may be placed outside the optical path between the polarizing beam splitter 328 and the focusing lens 350. The focusing lens 350 may condense the first and second laser beams L1, L2 that have passed through the polarizing beam splitter 328 onto the substrate W supported on the stage 20.

For example, the first beam block portion 324a may allow the passage of the first laser beam L1, and the second beam blocking portion 324b may allow the passage of the second laser beam L2. The first aberration corrector 332a may modulate the phase of the first laser beam L1 in response to the control signal from the controller 40, and the second aberration corrector 332b may modulate the phase of the second laser beam L2 in response to the control signal from the controller 40.

The polarizing beam splitter 342, the quarter wavelength plate 346, and the half wavelength plate 347 may move in a direction (−X direction) opposite to the first direction based on the operation mode. Accordingly, the first and second laser beams L1, L2 may be focused onto the substrate W, which is a processing target, without passing through the polarizing beam splitter 342, the quarter wavelength plate 346, and the half wavelength plate 347. The aberration sensor 348 may not receive the reflected light of the laser beam L1, L2.

A driving portion of the laser processing apparatus 10 may move the first and second laser beams L1, L2 in a second horizontal direction (Y direction) different from the first horizontal direction (X direction) with respect to the substrate W to scan the first and second laser beams L1, L2 along cutting lines S on the substrate W. The first and second laser beams L1, L2 may be focused such that a focus position P1 of the first laser beam L1 and a focus position P2 of the second laser beam L2 are different from each other. In the processing mode of the substrate W, the first laser beam L1 may have a focus position P1 at a first depth d1 from the surface of the substrate W, and the second laser beam L2 may have a focus position P2 at a second depth d2 greater than the first depth from the surface of the substrate W. Here, the focal positions P1, P2 of the first and second laser beams L1, L2 may have the same XY plane coordinate.

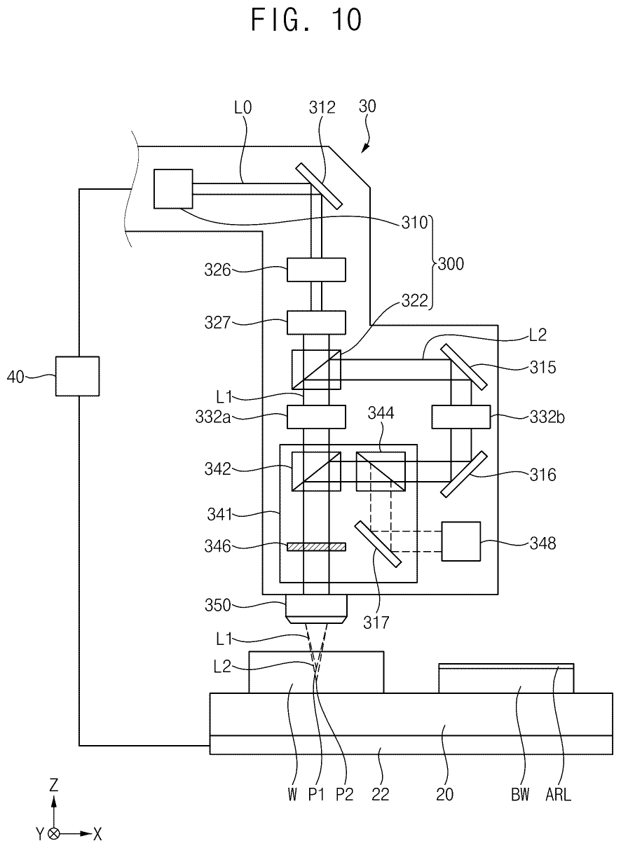

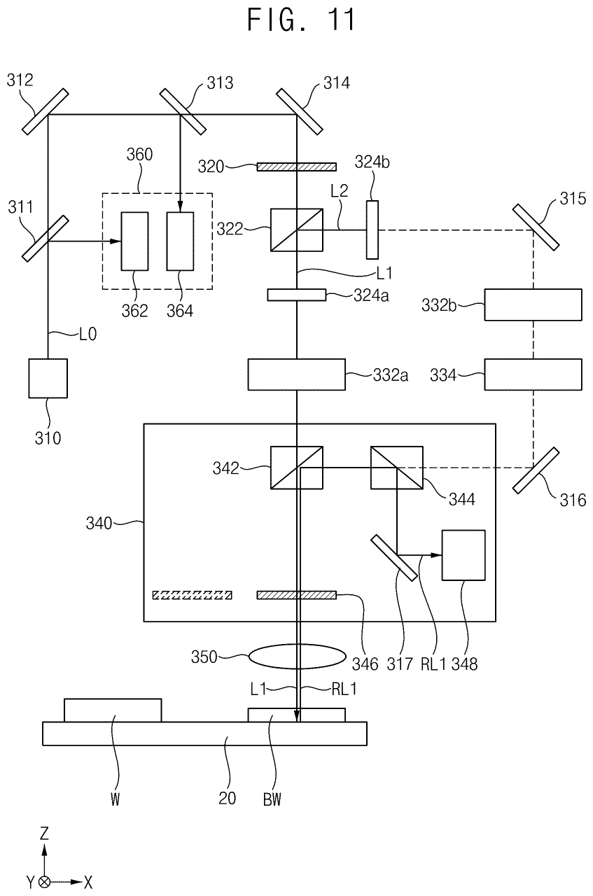

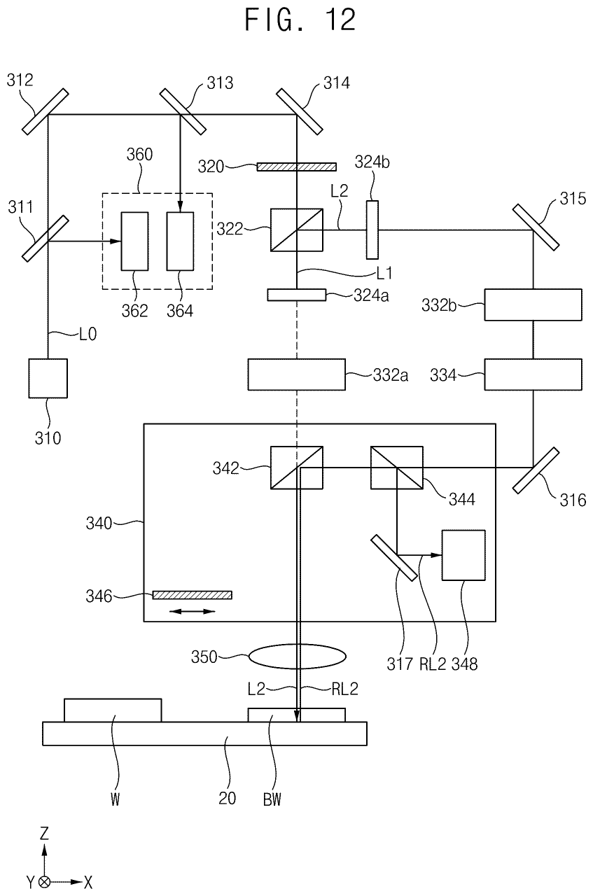

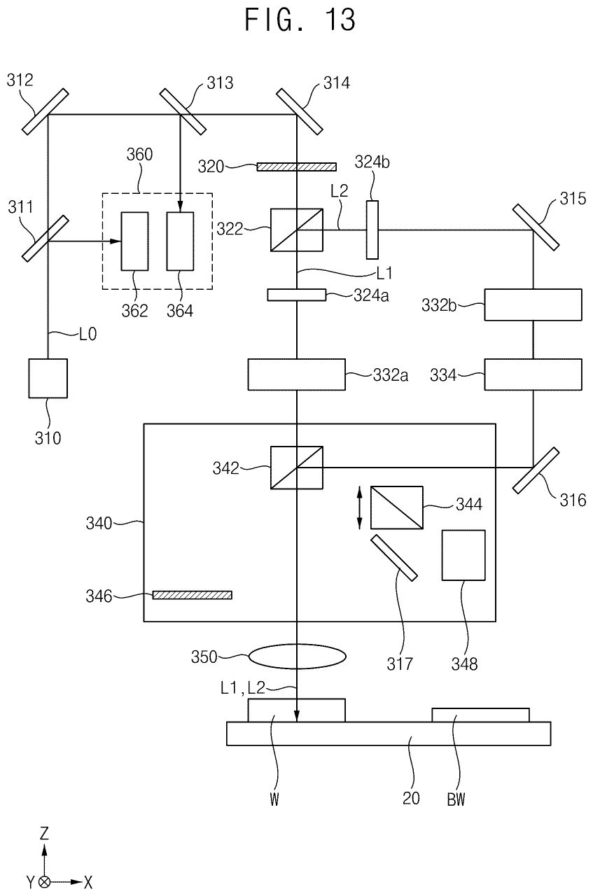

FIG. 10 is a block diagram illustrating a laser processing apparatus in accordance with example embodiments. FIG. 11 is a block diagram illustrating a measuring mode of first laser beam performed in the laser processing apparatus of FIG. 10. FIG. 12 is a block diagram illustrating a measuring mode of second laser beam performed in the laser processing apparatus of FIG. 10. FIG. 13 is a block diagram illustrating a processing mode performed in the laser processing apparatus of FIG. 10. The laser processing apparatus may be substantially the same as the laser processing apparatus described with reference to FIGS. 6 to 9, except for a configuration of a laser output portion that outputs first and second laser beams and a configuration of an aberration measuring optical system. Thus, same reference numerals will be used to refer to the same or like elements and any further repetitive explanation concerning the above elements will be omitted.

Referring to FIGS. 10 to 13, a laser irradiator 30 may include a laser output portion 300 to output a first laser beam L1 and a second laser beam L2, a focusing lens 350 to focus the first laser beam L1 and the second laser beam L2 onto a substrate W, and an aberration measuring optical system 340 to measure aberration of the first laser beam L1 and the second laser beam L2 passing through the focusing lens 350. The laser output portion 300 may further include a laser measurement portion 360 configured to measure a waveform, power, etc. of the laser beam output from a laser light source 310.

In some example embodiments, a portion of a laser beam L0 output from the laser light source 310 may be reflected by a beam splitter 311, 313 and may be directed to the laser measurement portion 360. The laser measurement portion 360 may include a pulse monitor 362 to measure the waveform of the laser beam and a power meter 364 to measuring the power of the laser beam. The pulse monitor 362 may measure the waveform of the laser beam L0 reflected by the beam splitter 311. The power meter 364 may measure the power of the laser beam L0 that has passed through the beam splitter 311 and then has been reflected by a mirror 312 and the beam splitter 313. For example, each of the beam splitters 311, 313 may have a transmittance of 99% and a reflectance of 1%, but example embodiments are not limited thereto.

The laser beam L0 that has passed through the beam splitters 311, 313 may pass through a wavelength plate 320. The wavelength plate 320 may change polarization of the laser beam L0. For example, the wavelength plate 320 may adjust the polarization of the laser beam L0 such that the polarization component of the laser beam L0 has 50% P polarization and 50% S polarization. The laser beam L0 that has passed through the wavelength plate 320 may be split into a first laser beam L1 and a second laser beam L2 by a polarizing beam splitter 322 based on the polarization. For example, the first laser beam L1 may be S polarized and the second laser beam L2 may be P polarized.

In some example embodiments, the aberration measuring optical system 340 may include an optical path forming portion 341 and an aberration sensor 348. The optical path forming portion 341 may transmit the first and second laser beams L1, L2 provided from the laser output portion 300 to the focusing lens 350, and may transmit laser beams RL1, RL2 reflected by a reflective structure BW after passing through the focusing lens 350, to the aberration sensor 348. The optical path forming portion 341 may include a polarizing beam splitter 342, a reflective beam splitter 344, and a quarter wavelength plate 346.

For example, the first laser beam L1 may pass through a first aberration corrector 332a to the polarizing beam splitter 342 of the aberration measuring optical system 340, and the second laser beam L2 may pass through a second aberration corrector 332b to the polarizing beam splitter 342 of the aberration measuring optical system 340. For example, the first laser beam L1 may be incident on a first surface of the polarizing beam splitter 342 along a vertical direction (Z direction), and the second laser beam L2 may be incident on a second surface of the polarizing beam splitter 342 along a first horizontal direction (X direction). The first surface of the polarizing beam splitter 342 may be perpendicular to the vertical direction (Z direction), and the second surface of the polarizing beam splitter 342 may be adjacent to the first surface and perpendicular to the first horizontal direction (X direction).

The polarizing beam splitter 342 may transmit a laser beam having a first polarization direction and may reflect a laser beam having a second polarization direction perpendicular to the first polarization direction. The reflective beam splitter 344 may reflect a portion of the laser beam having the second polarization direction and may transmit the other portion. The reflective beam splitter 344 may be, for example, a cube beam splitter, but example embodiments are not limited thereto. The quarter wavelength plate 346 may be disposed on an optical path between the polarizing beam splitter 342 and a reflective structure BW to change the polarization direction of the laser beam transmitted through the polarizing beam splitter 342. The reflective beam splitter 344, the quarter wavelength plate 346, and the half wavelength plate 347 may be provided to be movable according to an operation mode of the laser processing apparatus 10. The laser processing apparatus 10 may include a movement mechanism to move the reflective beam splitter 344 and the quarter wavelength plate 346. The movement mechanism may move the reflective beam splitter 344 and the quarter wavelength plate 346 based on a control signal from a controller 40.

As illustrated in FIG. 11, in a first measuring mode for measuring aberration of the first laser beam L1, the polarizing beam splitter 342 and the quarter wavelength plate 346 may be disposed on an optical path between the first aberration corrector 332a and the focusing lens 350. The quarter wavelength plate 346 may be moved in a first direction (X direction) based on the operation mode. The focusing lens 350 may condense the first laser beam L1 that has passed through the polarizing beam splitter 342 onto the reflective structure BW supported on the stage 20. For example, the polarizing beam splitter 342, the quarter wavelength plate 346, and the focusing lens 350 may be positioned on the same axis.

For example, the first beam block portion 324a may allow the passage of the first laser beam L1, and the second beam block portion 324b may block the second laser beam L2. Accordingly, the laser output portion 300 may output the first laser beam L1 having a first polarization direction (P polarization), and the polarizing beam splitter 342 may transmit the first laser beam L1 having the first polarization direction. The first laser beam L1 having the first polarization direction may pass through the quarter wavelength plate 346 and the may be incident on the reflective structure BW, and the reflected light RL1 of the first laser beam may pass through the quarter wavelength plate 346 and may be incident again to the polarizing beam splitter 342. The quarter wavelength plate 346 may delay a phase of light passing therethrough by ¼ wavelength. The reflected light RL1 of the first laser beam incident again to the polarizing beam splitter 342 may be changed to have a second polarization direction (S polarization), the laser beam passed through the quarter wavelength plate 346 twice.

The polarizing beam splitter 342 may reflect the laser beam having the second polarization direction, so the polarizing beam splitter 342 may reflect the reflected light RL1 of the first laser beam. Accordingly, the reflected light RL1 of the first laser beam may be incident on the aberration sensor 348.

As illustrated in FIG. 12, in a second measuring mode for measuring aberration of the second laser beam L2, the polarizing beam splitter 342 and the reflective beam splitter 344 may be disposed on an optical path between the second aberration corrector 332b and the focusing lens 350. The reflective beam splitter 344 may move in the vertical direction (Z direction) based on the operation mode. The focusing lens 350 may condense the second laser beam L2 that has passed through the reflective beam splitter 344 and the polarizing beam splitter 342 onto the reflective structure BW supported on the stage 20.

For example, the first beam block portion 324a may block the first laser beam L1, and the second beam block portion 324b may allow the passage of the second laser beam L2. Accordingly, the laser output portion 300 may output the second laser beam L2 having a second polarization direction (S polarization), and the second laser beam L2 may pass through the reflective beam splitter 344 and then may be incident on the polarizing beam splitter 342.

A portion of the second laser beam L2 having the second polarization direction may pass through the reflective beam splitter 344, may be reflected by the polarizing beam splitter 342, and then may be incident on the reflective structure BW, and the reflected light RL2 of the second laser beam may be incident again on the polarizing beam splitter 342. Since the polarizing beam splitter 342 reflects the laser beam having the second polarization direction, the polarizing beam splitter 342 may reflect the reflected light RL2 of the second laser beam. Accordingly, the reflected light RL2 of the second laser beam may be incident on the reflective beam splitter 344. Since the reflective beam splitter 344 reflects a portion of the laser beam having the second polarization direction, a portion of the reflected light RL2 of the second laser beam may be reflected by the reflective beam splitter 344. Accordingly, the portion of the reflected light RL2 of the second laser beam may be received by the aberration sensor 348 after being reflected by the mirror 317.

As illustrated in FIG. 13, in the processing mode for processing the substrate W, the reflective beam splitter 344 may be disposed outside the optical path between the second aberration corrector 332b and the polarizing beam splitter 342, and the quarter wavelength plate 346 may be disposed outside the optical path between the polarizing beam splitter 342 and the focusing lens 350. The focusing lens 350 may condense the first laser beam L1 that has passed through the polarizing beam splitter 342 onto the substrate W supported on the stage 20, and may condense the second laser beam L2 reflected by the polarizing beam splitter 342 onto the substrate W supported on the stage 20.

For example, the first beam block portion 324a may allow the passage of the first laser beam L1, and the second beam block portion 324b may allow the passage of the second laser beam L2. The first aberration corrector 332a can modulate the phase of the first laser beam L1 in response to the control signal from the controller 40, and the second aberration corrector 332b may modulate the phase of the second laser beam L2 in response to the control signal from the controller 40.

The reflective beam splitter 344 may move in in a direction (-Z direction) opposite to the vertical direction based on the operation mode, and the quarter wavelength plate 346 may move in in a direction (−X direction) opposite to the first direction based on the operation mode. Accordingly, the first laser beam L1 may be focused onto the substrate W, which is the object to be processed, without passing through the quarter wavelength plate 346, and the second laser beam L2 may be focused onto the substrate W, which is the object to be processed, without passing through the reflective beam splitter 344 and the quarter wavelength plate 346.

Hereinafter a laser processing method using the laser processing apparatus of FIGS. 2, 6 and 10 will be described.

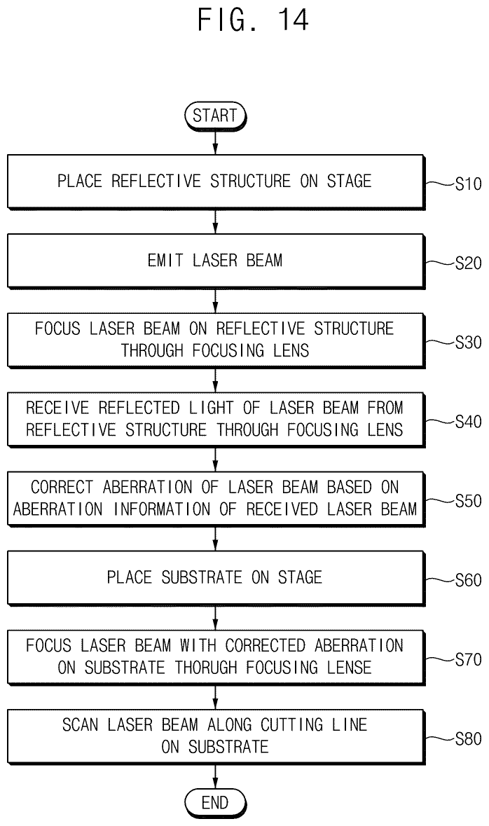

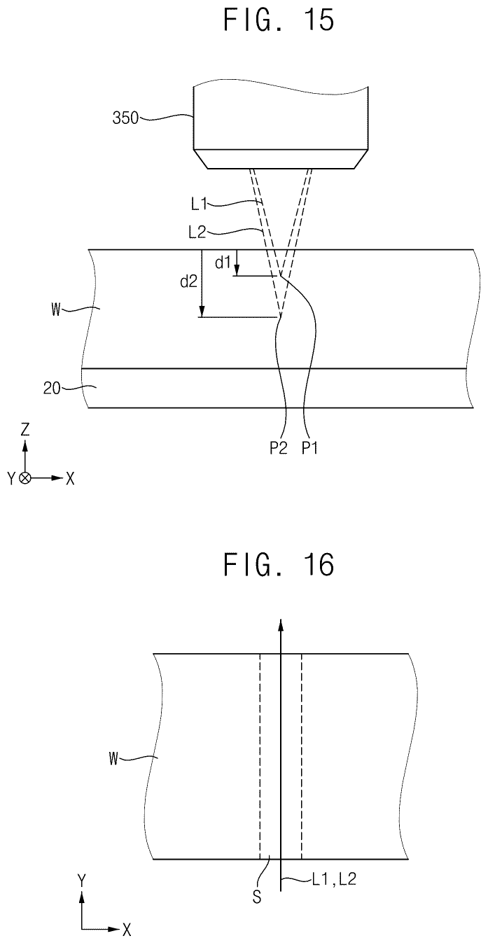

FIG. 14 is a flow chart illustrating a laser processing method in accordance with example embodiments. FIG. 15 is a cross-sectional view illustrating a wafer irradiated with two first and second laser beams. FIG. 16 is a plan view illustrating a scan line on the wafer along which the first and second laser beams of FIG. 15 are scanned.

Referring to FIGS. 1 to 16, first, a reflective structure BW may be supported on a stage 20 (S10), a laser beam L1, L2 may be emitted (S20), the laser beam L1, L2 may be focused on (for example, onto) the reflective structure BW through a focusing lens 350 (S40), reflected light LR1, LR2 of the laser beam from the reflective structure BW may be received through the focusing lens 350 (S50), and aberration of the laser beam L1, L2 may be corrected based on aberration information of the reflected light LR1, LR2 of the received laser beam (S50).

In some example embodiments, the stage 20 may support a substrate W as a processing target and the reflective structure BW for measuring the laser beam. The stage 20 may move the substrate W and the reflective structure BW based on an operation mode. The stage 20 may position the reflective structure BW at a focus of the focusing lens 350 in a measuring mode of the laser beam L1, L2. The focusing lens 350 may condense the laser beam L1, L2 from a laser output portion 300 onto the reflective structure BW on the stage 20.

An aberration measuring optical system 340 may measure the aberration of the laser beam by receiving the reflected light RL1, RL2 of the laser beam from the reflective structure BW through the focusing lens 350. The aberration measuring optical system 340 may include an optical path forming portion 341 and an aberration sensor 348. The optical path forming portion 341 may guide the reflected light RL1, RL2 of the laser beam from the reflective structure BW that passes through the focusing lens 350, to the aberration sensor 348. The laser processing apparatus 10 may adjust the polarization direction of the laser beam L1, L2 using the optical path forming portion 341 to receive the laser beam L1, L2 that has passed through the focusing lens 350 by the aberration sensor 348.

An aberration corrector 332, 332a, 332b may be provided on an optical path of the laser beam L1, L2 incident from the laser output portion 300 to the focusing lens 350 and may correct the aberration of the laser beam. The aberration corrector 332, 332a, 332b may correct the aberration of the laser beam L1, L2 based on the aberration information of the laser beam measured by the aberration measuring optical system 340.

A controller 40 may analyze the aberration of the laser beam measured by the aberration sensor 348, may calculate a correction value that makes the value of each type of aberration approach 0, and may output a control signal reflecting the aberration to the aberration corrector 332, 332a, 332b. The aberration corrector 332, 332a, 332b may modulate the phase of the laser beam L1, L2 in response to the control signal. Accordingly, the aberration of the laser beam L1, L2 may be removed or reduced.

Then, the substrate W as a processing target may be placed on the stage 20 (S60), and the laser beam L1, L2 having the corrected aberration may be focused on the substrate W through the focusing lens 350 (S70), and the laser beam L1, L2 may be scanned along cutting lines S on (for example, of) the substrate W (S80).

In some example embodiments, the stage 20 may position the substrate W on the focus of the focusing lens 350 in a processing mode of the laser beam L1, L2. The focusing lens 350 may condense the laser beam L1, L2 from the laser output portion 300 onto the substrate W on the stage 20.

A driving portion of the laser processing apparatus 10 may move the laser beam L1, L2 in a second horizontal direction (Y direction) different from a first horizontal direction (X direction) with respect to the substrate W to scan the laser beam L1, L2 along the cutting lines S on the substrate W. For example, the second horizontal direction may be a direction (Y direction) perpendicular to the first horizontal direction (X direction).

In some example embodiments, the laser output portion 300 may include a beam splitter 322 to split a laser beam L0 from a laser light source 310 into a first laser beam L1 and a second laser beam L2. A focus position adjuster 334 may be provided on a first optical path of the first laser beam L1 and/or a second optical path of the second laser beam L2 to adjust a focus position P1 of the first laser beam L1 and/or a focus position P2 of the second laser beam L2. The focus position adjuster 334 may adjust the focus position P1 of the first laser beam L1 and the focus position P2 of the second laser beam L2 to be different from each other.

As illustrated in FIGS. 15 and 16, in the processing mode, the first laser beam L1 may have a focus position P1 at a first depth d1 from a surface of the substrate W, and the second laser beam L2 may have a focus position P2 at a second depth d2 greater than the first depth from the surface of the substrate W. Here, the focus positions P1, P2 of the first and second laser beams L1, L2 may have the same XY plane coordinate.

When first and second laser beams L1, L2 having different depths d1, d2 are focused within the substrate W, local melting, expansion, shrinkage, and solidification processes may occur at first and second spots P1, P2. During the shrinkage process, the left and right areas of the first and second spots P1, P2 may shrink first, so that cracks are generated at the center of the first and second spots P1, P2, and when the shrinkage is complete, the cracks may grow in the vertical direction to form vertical cracks. Through the above process, when the substrate W and the first and second laser beams L1, L2 are intermittently irradiated while relatively moving along the cutting line S, a stealth dicing line may be formed along the second horizontal direction (Y direction) inside the substrate W.

The semiconductor package formed by the above-described laser processing apparatus may include semiconductor devices such as logic devices or memory devices. The semiconductor package may include logic devices such as, for example, central processing units (CPUs), main processing units (MPUs), or application processors (Aps), or the like, and volatile memory devices such as DRAM devices, HBM devices, or non-volatile memory devices such as flash memory devices, PRAM devices, MRAM devices, ReRAM devices, or the like.

The foregoing is illustrative of some example embodiments and is not to be construed as limiting thereof. Although a few example embodiments have been described, those ordinarily skilled in the art will readily appreciate that many modifications are possible in example embodiments without materially departing from the novel teachings and advantages of the present inventive concepts. Accordingly, all such modifications are intended to be included within the scope of example embodiments as defined in the claims.

One or more of the elements disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

What is claimed is:

1. A laser processing apparatus, comprising:
a stage configured to support a substrate as a processing target and to support a reflective structure for measurement;
a laser output portion configured to output a laser beam;
a focusing lens configured to focus the laser beam onto the substrate in a processing mode for processing the substrate and to focus the laser beam onto the reflective structure in a measuring mode for measuring the laser beam;
an aberration measuring optical system configured to receive through the focusing lens light of the laser beam that is reflected by the reflective structure and to measure aberration of the laser beam; and
an aberration corrector on an optical path of the laser beam from the laser output portion to the focusing lens, the aberration corrector configured to correct aberration of the laser beam based on measured aberration information of the laser beam.

2. The laser processing apparatus of claim 1, wherein the aberration measuring optical system includes:
a polarizing beam splitter configured to transmit a laser beam having a first polarization direction and to reflect a laser beam having a second polarization direction that is perpendicular to the first polarization direction;
a wavelength plate on an optical path between the polarizing beam splitter and the reflective structure and configured to change the polarization direction of the laser beam transmitted through the polarizing beam splitter; and
an aberration sensor configured to receive light of the laser beam that is reflected by the polarizing beam splitter and to measure aberration of the laser beam, and
wherein the polarizing beam splitter and the wavelength plate are movable so as to be outside the optical path of the laser beam in the processing mode and to be on the optical path of the laser beam in the measuring mode.

3. The laser processing apparatus of claim 2, wherein the laser processing apparatus is configured such that, in the measuring mode,
the laser beam having the first polarization direction passes through the polarizing beam splitter and through the wavelength plate before being focused by the focusing lens onto the reflective structure, and
light of the laser beam that is reflected by the reflective structure passes through the focusing lens and through the wavelength plate and is reflected by the polarizing beam splitter before being incident on the aberration sensor.

4. The laser processing apparatus of claim 3, wherein the wavelength plate includes a quarter wavelength plate.

5. The laser processing apparatus of claim 1, wherein the laser beam includes a first laser beam having a first polarization direction and a second laser beam having a second polarization direction that is perpendicular to the first polarization direction, the measuring mode of the laser beam including a measuring mode for the first laser beam and a measuring mode for the second laser beam,
wherein the aberration measuring optical system includes
a polarizing beam splitter configured to transmit a laser beam having the first polarization direction and to reflect a laser beam having the second polarization direction;
a quarter wavelength plate on an optical path between the polarizing beam splitter and the reflective structure, the quarter wavelength plate being configured to change the polarization direction of a laser beam that is transmitted through the polarizing beam splitter;
a half wavelength plate on an optical path of the laser beam from the laser output portion to the polarizing beam splitter, the half wavelength plate configured to change a laser beam having the second polarization direction into a laser beam having the first polarization direction; and
an aberration sensor configured to measure the aberration of the laser beam by receiving light of the laser beam that is reflected by the polarizing beam splitter, and
wherein the polarizing beam splitter, the quarter wavelength plate and the half wavelength plate are movable so as to be outside the optical path of the laser beam in the processing mode, the polarizing beam splitter and the quarter wavelength plate are movable so as to be on the optical path of the first laser beam in the measuring mode of the first laser beam, and the polarizing beam splitter, the quarter wavelength plate, and the half wavelength plate are movable so as to be on the optical path of the second laser beam in the measuring mode of the second laser beam.

6. The laser processing apparatus of claim 5, wherein the laser processing apparatus is configured such that,
in the measuring mode of the first laser beam,
the first laser beam passes through the polarizing beam splitter, passes through the quarter wavelength plate, and is focused onto the reflective structure by the focusing lens, and light of the first laser beam that is reflected by the reflective structure passes through the focusing lens and the quarter wavelength plate, is reflected onto the polarizing beam splitter, and is then incident on the aberration sensor, and
in the measuring mode of the second laser beam,
the second laser beam passes through the half wavelength plate, passes through the polarizing beam splitter, passes through the quarter wavelength plate, and is focused onto the reflective structure by the focusing lens, and light of the second laser beam reflected by the reflective structure passes through the focusing lens and the quarter wavelength plate, is reflected onto the polarizing beam splitter and is then incident on the aberration sensor.

7. The laser processing apparatus of claim 1, wherein the laser beam includes a first laser beam having a first polarization direction and a second laser beam having a second polarization direction that is perpendicular to the first polarization direction, the measuring mode for measuring the laser beam including a measuring mode for the first laser beam and a measuring mode for the second laser beam,
wherein the aberration measuring optical system comprises
a polarizing beam splitter configured to transmit a laser beam having the first polarization direction and to reflect a laser beam having the second polarization direction;
a beam splitter configured to reflect a portion of the laser beam having the second polarization direction and to transmit another portion of the laser beam;
a quarter wavelength plate on an optical path between the polarizing beam splitter and the reflective structure, the quarter wavelength plate configured to change the polarization direction of the laser beam transmitted through the polarizing beam splitter; and
an aberration sensor configured to receive a reflected light of the laser beam reflected by the polarizing beam splitter and to measure the aberration of the laser beam, and
wherein the beam splitter and the quarter wavelength plate are movable so as to be outside the optical path of the laser beam in the processing mode, and the polarizing beam splitter, the beam splitter and the quarter wavelength plate are movable so as to be on the optical path of the first laser beam in the measuring mode of the first laser beam, and the polarizing beam splitter and the beam splitter are movable so as to be on the optical path of the second laser beam in the measuring mode of the second laser beam.

8. The laser processing apparatus of claim 7, wherein the laser processing apparatus is configured such that
in the measuring mode of the first laser beam,
the first laser beam passes through the polarizing beam splitter, passes through the quarter wavelength plate, and is focused onto the reflective structure by the focusing lens, and light of the first laser beam that is reflected by the reflective structure passes through the focusing lens and the quarter wavelength plate is sequentially reflected by the polarizing beam splitter and the beam splitter, and is then incident on the aberration sensor, and
in the measuring mode of the second laser beam,
the second laser beam passes through the beam splitter, is reflected by the polarizing beam splitter, and is focused onto the reflective structure by the focusing lens, and the reflected light of the second laser beam reflected by the reflective structure is sequentially reflected by the polarizing beam splitter and the beam splitter, and is then incident on the aberration sensor.

9. The laser processing apparatus of claim 1, wherein the aberration corrector includes a spatial light modulator that is configured to adjust a phase of the laser beam.

10. The laser processing apparatus of claim 1, wherein the reflective structure includes a silicon wafer.

11. A laser processing apparatus, comprising:
a stage configured to support a substrate as a processing target and to support a reflective structure for measurement;
a laser output portion configured to output a first laser beam having a first polarization direction and a second laser beam having a second polarization direction that is perpendicular to the first polarization direction;
a focusing lens configured to focus the first and second laser beams onto the substrate in a processing mode for processing the substrate and to respectively focus the first and second laser beams onto the reflective structure in measuring modes for measuring the first and second laser beams;
an aberration measuring optical system configured to receive through the focusing lens light of each of the first and second laser beams that is reflected by the reflective structure and to measure aberration of each of the first and second laser beams;
a first aberration corrector on an optical path of the first laser beam from the laser output portion to the focusing lens, the first aberration corrector configured to correct aberration of the first laser beam based on measured aberration information of the first laser beam; and
a second aberration corrector on an optical path of the second laser beam incident from the laser output portion to the focusing lens, the second aberration corrector configured to correct aberration of the second laser beam based on measured aberration information of the second laser beam.

12. The laser processing apparatus of claim 11, wherein the aberration measuring optical system includes:
a polarizing beam splitter configured to transmit a laser beam having the first polarization direction and to reflect a laser beam having the second polarization direction;
a quarter wavelength plate on an optical path between the polarizing beam splitter and the reflective structure, the quarter wavelength plate configured to change the polarization direction of the laser beam that is transmitted through the polarizing beam splitter; and
a half wavelength plate on an optical path of the laser beam from the laser output portion to the polarizing beam splitter, the half wavelength plate configured to change a laser beam having the second polarization direction into a laser beam having the first polarization direction; and
an aberration sensor configured to receive the light of the laser beam that is reflected by the polarizing beam splitter and to measure the aberration of the laser beam.

13. The laser processing apparatus of claim 12, wherein the polarizing beam splitter, the quarter wavelength plate, and the half wavelength plate are outside the optical path of the laser beam in the processing mode, the polarizing beam splitter and the quarter wavelength plate are on the optical path of the first laser beam in the measuring mode of the first laser beam, and the polarizing beam splitter, the quarter wavelength plate, and the half wavelength plate are on the optical path of the second laser beam in the measuring mode of the second laser beam.

14. The laser processing apparatus of claim 11, wherein the aberration measuring optical system includes:
a polarizing beam splitter configured to transmit a laser beam having the first polarization direction and to reflect a laser beam having the second polarization direction;
a beam splitter configured to reflect a portion of the laser beam having the second polarization direction and to transmit another portion of the laser beam;
a quarter wavelength plate on an optical path between the polarizing beam splitter and the reflective structure, the quarter wavelength plate configured to change the polarization direction of the laser beam that is transmitted through the polarizing beam splitter; and
an aberration sensor configured to receive light of the laser beam that is reflected by the polarizing beam splitter and to measure the aberration of the laser beam.

15. The laser processing apparatus of claim 14, wherein the beam splitter and the quarter wavelength plate are outside the optical path of the laser beam in the processing mode, the polarizing beam splitter, the beam splitter, and the quarter wavelength plate are on the optical path of the first laser beam in the measuring mode of the first laser beam, and the polarizing beam splitter and the beam splitter are on the optical path of the second laser beam in the measuring mode of the second laser beam.

16. The laser processing apparatus of claim 11, wherein each of the first and second aberration correctors includes a spatial light modulator that is configured to adjust a phase of each of the first and second laser beams.

17. The laser processing apparatus of claim 11, wherein in the processing mode, the first laser beam has a focus position at a first depth from a surface of the substrate and the second laser beam has a focus position at a second depth from the surface of the substrate, the second depth being greater than the first depth.

18. The laser processing apparatus of claim 11, wherein the reflective structure includes a mirror having a thickness smaller than a thickness of the substrate.

19. The laser processing apparatus of claim 18, wherein an anti-reflection layer is on a surface of the mirror.

20. A laser processing apparatus, comprising:
a stage configured to support a reflective structure;
a laser output portion configured to output a laser beam;
a focusing lens configured to focus the laser beam on the reflective structure;
an aberration measuring optical system configured to receive through the focusing lens light of the laser beam that is reflected by the reflective structure to measure aberration of the laser beam; and
an aberration corrector on an optical path of the laser beam from the laser output portion to the focusing lens, the aberration corrector configured to correct the aberration of the laser beam based on measured aberration information of the laser beam, and
the aberration measuring optical system includes
a polarizing beam splitter configured to transmit a laser beam having a first polarization direction and to reflect a laser beam having a second polarization direction that is perpendicular to the first polarization direction;
at least one wavelength plate on an optical path between the polarizing beam splitter and the reflective structure, the at least one wavelength plate configured to change the polarization direction of the laser beam transmitted through the polarizing beam splitter; and
an aberration sensor configured to receive light of the laser beam that is reflected by the polarizing beam splitter, the aberration sensor configured to measure the aberration of the laser beam,
wherein the at least one wavelength plate is on the optical path or outside the optical path.
